(19) United States
(12) Patent Application Publication
(10) Pub. No.: US 2012/0198977 A1
(43) Pub. Date: Aug. 9, 2012

(54) METHOD FOR MAKING AN OPENING IN A SUBSTRATE

(75) Inventors: Florian Roick, Verden (DE); Christian Kohlmeier, Lauenhagen (DE); Stefan Boenigk, Hannover (DE)

(73) Assignee: LPKF LASER & ELECTRONICS AG, Garbsen (DE)

(21) Appl. No.: 13/366,396

(22) Filed: Feb. 6, 2012

(30) Foreign Application Priority Data
Feb. 7, 2011 (DE) 10 2011 000 529.3

(51) Int. Cl. B26D 3/00

(52) U.S. Cl. 83/39

(57) ABSTRACT

A method for making an opening in a substrate includes creating a cutting path in the substrate for cutting out a polygonal area along predetermined side paths which enclose the opening and are connected to each other via respective corner points. The cutting path is started in an internal region of the polygonal area at a distance from the side paths. The cutting path is continued in a recess in the internal region to a start point on a first one of the side paths, the start point being disposed along the first one of the side paths at a substantial distance from each of the respective corner points so as to divide the first one of the side paths into a long side path portion and a short side path portion. The cutting path is continued, from the start point, along each of the side paths.

### CROSS-REFERENCE TO PRIOR APPLICATIONS

Priority is claimed to German Patent Application No. DE 10 2011 000 529.3, filed on Feb. 7, 2011, the entire disclosure of which is hereby incorporated by reference herein.

### FIELD

The invention relates to a method for making an opening in a substrate using electromagnetic radiation.

### BACKGROUND

A method for making an opening in a substrate is for example used in the manufacture of soldering paste stencils for the electronics industry, which are used for applying soldering paste in the industrial manufacturing process of printed circuit boards. The thus produced stencils consist, for example, of polyimide or steel. With the stencils produced by this method, the soldering paste can be applied rapidly and reliably.

Soldering paste stencils are used for applying solder deposits to the printed circuit board. Subsequently, the SMD components (SMD=surface mounted device) are placed in the solder deposits and soldered in a subsequent reflow soldering process. Soldering paste stencils may, depending on customer requirements, be manufactured as blank metal sheets, as stencils with edge perforations, or so as to be glued in the frame. For this purpose, individual openings are made in the metal sheet.

To make openings which are enclosed on all sides in a substrate, in the prior art, the focus point is placed not for example on the side paths, but inside the area of the opening to be removed. Based on this focus point, initially the laser focus is positioned, and subsequently the recess, also referred to as a recess vane, is continued to a corner point of two side paths which forms a start point for the cutting path. Subsequently, the linear cutting path is made along each of the side paths defining the clearance.

In practice, however, undesirable deformation occurs before the start point is reached again after a complete cycle along the side paths. The area which is to be cut out and is already mostly separated is bent downwards under the effect of gravity and of the force resulting from the gas flow of the process gases, the gas flow providing rapid removal of the melt and preventing re-adhesion.

On the one hand, this has a detrimental effect on the removal of the melt, since it means that the melt can re-adhere to the cutting edge, and on the other hand, the cutting edge becomes imprecise because the laser beam is no longer orthogonal to the surface, but as a result of the bending impinges on a convexly deformed region of the surface at a different angle at the side path, and the preset parameters of the laser are no longer optimal.

It would be conceivable to make the openings in two successive working steps, in such a way that initially an internal sub-region having a large proportion of the mass is removed, and subsequently the remaining rim is removed with an exact contour along the side paths. However, this undesirably prolongs the process, and so this proposed solution has been found to be impractical.

### SUMMARY OF THE INVENTION

In an embodiment, the present invention provides a method for making an opening in a substrate. A cutting path is created in the substrate using electromagnetic radiation for cutting out a polygonal area along predetermined side paths which enclose the opening and are connected to each other via respective corner points. The cutting path is started in an internal region of the polygonal area at a distance from the side paths. The cutting path is continued in a recess in the internal region to a start point on a first one of the side paths, the start point being disposed along the first one of the side paths at a substantial distance from each of the respective corner points so as to divide the first one of the side paths into a long side path portion and a short side path portion. The cutting path is continued, from the start point on the first one of the side paths onward along each of the side paths.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a prior art method;

FIG. 2 shows a method according to an embodiment of the invention for making an opening in a substrate.

### DETAILED DESCRIPTION

In an embodiment, an option for minimising disadvantageous effects resulting from deformation-based changes in the orientation of the area which has been cut out in part is provided.

Thus, according to an embodiment of the invention, a method is provided in which the recess is continued from the internal region to a start point, which is at a substantial distance from a point of discontinuity, in particular a corner point connecting two side paths, in such a way that the start point subdivides the side path into a long side path portion and a short side path portion. Starting from the focus point made in the surface, the invention is based on the finding of guiding the recess not to a corner point, but to the side path at a predetermined distance from said corner point, in such a way that the start point subdivides the side path into a short side path portion and a long side path portion. Subsequently, the cutting path is made along all of the side paths. However, an advantageous effect, which is surprising based on the prior art, occurs before the start point is reached again after a complete cycle along the side paths. The fact that the cutting path is initially still absent in the short side path portion leads to rigidification in the manner of a support. By contrast with the prior art, in which the area is cantilevered shortly before the start point is reached again, i.e. only has a support along one side path, the area initially has an additional support which is formed by the short side path portion. In this case, although the largely cut-out area is still deformed relative to the substrate under the effect of external forces, this bend line does not extend parallel to the side path, but at an angle thereto, in particular orthogonal thereto, in such a way that the disadvantageous effects do not occur.

In an embodiment, it is found to be particularly advantageous if the cutting path, starting from the start point, is made starting with the long side path portion and the adjacent side paths, in such a way that the side path portion forming the support is limited to the short side path portion. Surprisingly, it has been found that even a very short length of the short side path portion is perfectly sufficient to achieve the advantages according to the invention. In addition, the initially advantageous deformation along a bend line other than the side path provides that the bend line is different from the side path even when the cutting path is made along the short side path portion.

In this context, an embodiment of the method in which the length of the short side path portion is between 5% and 15%, in particular approximately 10%, of the total length, as the sum of the short side path portion and the long side path portion, is found to be particularly promising, since this means that the function of the support is performed optimally whilst at the same time the short side path portion is of a minimal length.

In an embodiment, it has been found to be expedient in practice if the short side path portion is made at a length of between 0.05 mm and 0.25 mm, so as to achieve optimum results in practice.

In an embodiment, the recess could exhibit any desired path, and could for example approach the side path asymptotically or be made so as to extend orthogonal to the side path. However, it is particularly advantageous if the recess forms an acute angle with the long side path portion, in such a way that the start point is defined unambiguously, and intersecting machining by a plurality of cutting paths in this region is excluded.

The recess can in principle be of any desired length. However, it is particularly advantageous if the recess is made at a length of between 20% and 30% of the side length of the side path which is connected to the short side path portion or to the long side path portion.

This provides controlled, predeterminable deformation of the area as the cutting path progresses. In this context, recess lengths of between 0.05 mm and 0.25 mm are preferred.

The recess can be guided to a start point on any desired side path. However, it is particularly expedient if the recess is connected to a start point on the longest side path.

The method according to the invention is not limited to particular sizes of the area to be cut out or of the substrate. However, application is particularly expedient for areas in which the side paths are of a length of between 50 μm and 10 mm.

In practice, the method according to the invention can be used in many fields. A preferred application of the invention involves the laser-cutting of stencils for applying soldering paste.

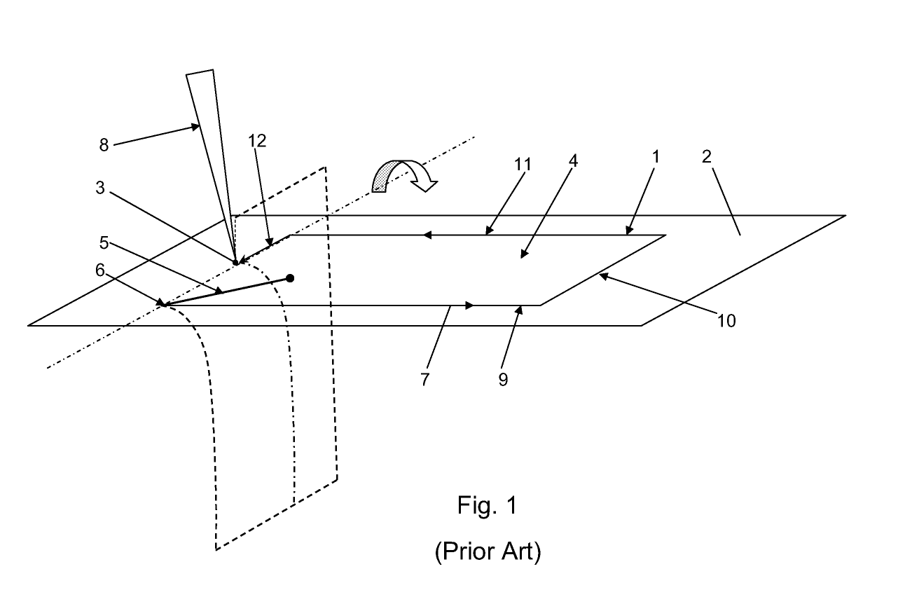

FIG. 1 shows a method for making an opening 1 in a substrate 2 such as is known from the prior art. Staring from a focus point 3 of focussed electromagnetic radiation 8 inside the area 4 which is to be cut out, a recess 5 is continued, as a cutting path 7, to a corner point 6 which is the point of intersection of two side paths 9, 12. Subsequently, all of the side paths 9, 10, 11, 12 are removed in an anti-clockwise direction, in such a way that in a central region of the final side path 12 there is deformation of the area 4, which at this stage is already predominantly cut out. As shown, the area 4 pivots about an axis orientated substantially parallel to the last side path 12 to be worked off. As a result, in the deformation region the focussed beam impinges on a convex surface of the area 4, resulting in changes in the dimensions of the cutting edge.

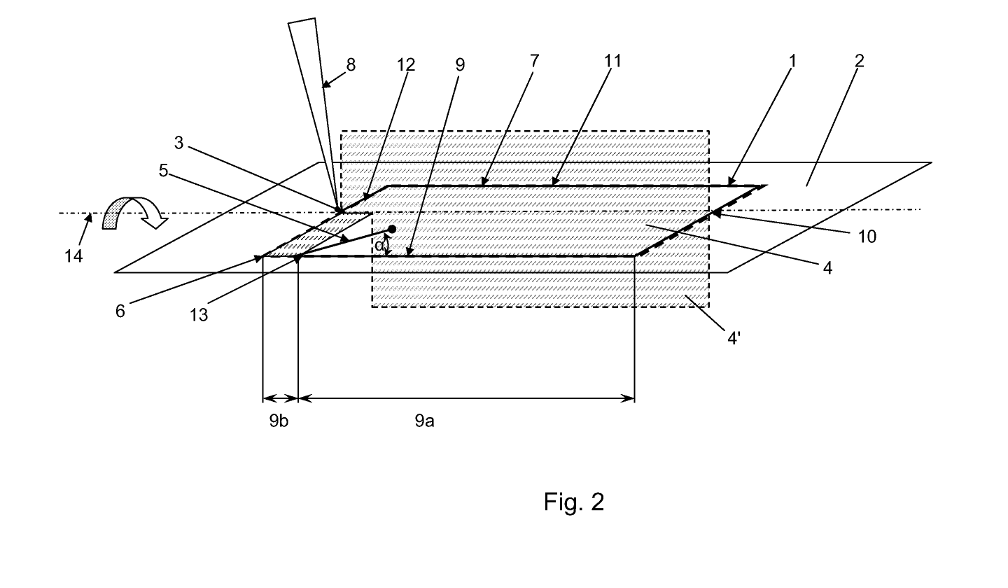

By contrast, FIG. 2 shows a method according to the invention for making the opening 1 in the substrate 2, in which changes of the aforementioned type in the dimensions are largely avoided. As described above, the cutting path 7, which is to be made by means of focussed electromagnetic radiation 8, initially starts inside a region, enclosed by the side paths 9, 10, 11, 12, of the area 4 to be removed, and continues as a recess 5 to a start point 13 on the first side path 9, which is at a distance from a corner point 6 connecting two side paths 9, 12. In this case, the start point 13 subdivides the side path 9 into a long side path portion 9a and a short side path portion 9b, the recess 5 forming an angle a with the long side path portion 9a. Subsequently, the cutting path 7 is made along the first side path 9 into the long side path portion 9a, and subsequently along the second side path 10 and the third side path 11 and up to approximately the middle of the fourth side path 12. However, an advantageous effect, which is surprising based on the prior art shown in FIG. 1, occurs before the start point 13 is reached again. The rigid connection to the short side path portion 9b leads to rigidification in the manner of a support. Unlike the remainder of the substrate 2, the area 4′, enclosed in dashed lines, which is deformed by the fluid flow of the process gases and by gravity, has a bend line 14 orthogonal to the fourth side path 12 in the same plane. As shown, the fourth side path 12 thus remains unimpaired by the deformation, in such a way that a substantially improved quality of the cutting path 7 can be achieved without any delay in the machining.

While the invention has been described with reference to particular embodiments thereof, it will be understood by those having ordinary skill the art that various changes may be made therein without departing from the scope and spirit of the invention. Further, the present invention is not limited to the embodiments described herein; reference should be had to the appended claims.

What is claimed is:

1. A method for making an opening in a substrate comprising:
creating a cutting path in the substrate using electromagnetic radiation for cutting out a polygonal area along predetermined side paths which enclose the opening and are connected to each other via respective corner points, the creating including:
starting the cutting path in an internal region of the polygonal area at a distance from the side paths;
continuing the cutting path in a recess in the internal region to a start point on a first one of the side paths, the start point being disposed along the first one of the side paths at a substantial distance from each of the respective corner points so as to divide the first one of the side paths into a long side path portion and a short side path portion; and
continuing the cutting path, from the start point on the first one of the side paths onward along each of the side paths.

2. The method as recited in claim 1, wherein the substrate includes a metal sheet.

3. The method as recited in claim 1, wherein the cutting path is continued from the start point along the long side path portion of the first one of the side paths to successively adjacent side paths and then along the short side path portion.

4. The method as recited in claim 1, wherein a length of the short side portion is between 5% and 15% of a total length of a sum of the length of the short side path portion and a length of the long side path portion.

5. The method as recited in claim 1, wherein the short side path portion has a length of between 0.05 mm and 0.25 mm.

6. The method as recited in claim 1, wherein the recess and the long side path portion form an angle with respect to each other.

7. The method as recited in claim 1, wherein the recess has a length of between 20% and 30% of at least one of an adjacent one of the side paths connected to the short side path portion and an adjacent one of the side paths connected to the long side path portion.

8. The method as recited in claim 1, wherein the recess has a length of between 0.05 mm and 0.25 mm.

9. The method as recited in claim 1, wherein the recess is connected to the start point on a longer one of the side paths.

10. The method as recited in claim 1, wherein each of the side paths has a length of between 50 μm and 10 mm.

11. The method as recited in claim 1, wherein the substrate is a stencil configured for a soldering paste application and wherein the cutting is performed using a laser.
